(19) United States
(12) Patent Application Publication
(10) Pub. No.: US 2011/0131726 A1
(43) Pub. Date: Jun. 9, 2011

(54) Multifunctional Turn-Over Nursing Bed

(76) Inventors: Yiping Wen, Yichun City (CN); Yuqing Zhong, Yichun City (CN)

(21) Appl. No.: 13/055,736

(22) PCT Filed: Jul. 30, 2009
(86) PCT No.: PCT/CN2009/073002

§ 371 Date: Feb. 21, 2011

(30) Foreign Application Priority Data
Jul. 31, 2008 (CN) 200820113297.2

(51) Int. Cl. A61G 7/02; A61G 7/002; A61G 7/05

(52) U.S. Cl. 5/604

(57) ABSTRACT

A turn-over nursing bed comprises a bed board composed of several plates. Said bed board comprises middle longitudinal plates (4, 9), left and right side plates (49) and a head plate and a foot plate at the both ends of the bed. The middle longitudinal plates (4, 9) and one of the side plates (49) turned up may form an “L” figure. The left and right side plates (49) are respectively composed of a side pillow plate (1), a hand laid plate (18) and a hip leaning plate (8), above three plates are disconnected one another. The side plate (49) is turned up by cooperation with a plate end shaft (15) at the foot plate, a plurality of hinge shafts (16) in the middle section of the bed board and a link shaft (5). The head plate and the foot plate are respectively composed of a centre fixed plate (2,13) and active plates 914) on both sides of the centre fixed plate (2,13), such that the bed can be narrowed. A monitor display (12) is mounted in the middle of the foot plate. The lower section of the middle longitudinal plates (4, 9) is provided with a toilet aperture (7) beneath which a movable frame (48) is located. Through the movement of the movable frame (48) the exchange of a toilet seat (45) and a toilet cover (43) at the toilet aperture (7) is achieved.

### TECHNICAL FIELD

The present invention relates to a bed, which belongs to the technical field of medical equipment.

### BACKGROUND

Why is it difficult to find nursing beds with turn-over functions in hospitals and on the market? It is not because people do not need turn-over beds but because there is a certain degree of difficulty in the design. The programmable shape-change medical bed with complete functions (patent number: z100222004), for example, has new conception in the turn-over mode, but it is difficult to market because of its lack of comfort for hand positioning after turn-over, inadaptability to patients with different build, failure to achieve excrement collection during side turn-over and other key functions. Thus, although there are thousands of pathbreakers who design turn-over beds, most of the designs are still in an exploratory stage, or the bed has a turn-over function symbolically but has little clinical effect in reality. The nursing bed with a luxurious and perfect appearance has few functions with actual values, and most of the functions are in aspects of laying, leaning, bending legs, tilting or lifting the bed surface. Even in the case of the most advanced hospital bed at present in the United States, the kGL three-dynamic electric bed for the recovery of patients with fatal illness, made by the US Simmons company, has four disadvantages besides the exquisite technique and strong high-tech infiltration: 1. the bed cannot collect excrement, and cannot collect excrement when a patient lie on one side; 2. the bed cannot be moved for a long distance even if the bed can be moved out of the door, because the bed body is heavy and the bed cannot be narrowed; 3. a patient is easily clamped by guard rail boards, and when the patient leans to one side, and the patient skin is repeatedly rubbed with the bed body because of the body sliding (the counter measure is to use special material to make the sheets, which provides extra capillary fiber holes for jet massage to reduce the friction); 4. the bed is expensive so that it cannot be accepted by ordinary hospitals and cannot be marketed widely.

What deserves to be mentioned is that all nursing beds in the world at present use the barrier type guard rail boards with holes. The guard rail board is arranged at the edge of the bed, and it functions to prevent the patient from falling from bed, but does not help with the turn-over. Because the guard rail board has many gaps, its negative effects cannot be overlooked. It leaves the risk that the patient may be clamped. In the 21 years from 1985 to 2006, the United States has received 691 reports that patients are clamped by guard rail boards, and 413 patients are dead because of the clamping. Thus, the US FDA (US Food and Drug Administration) specially issues a hospital bed design guideline on the defect to reduce the injury of guard rail boards to patients.

### Invention Contents

A multifunctional turn-over nursing bed is characterized in that the whole bed board is composed of nine plates. The middle longitudinal plates are composed of a back plate, a lower bed board and a toilet cover; the left and right side plates are respectively composed of a side pillow plate, a hand rest plate and a hip leaning plate, with the three plates disconnected from one another. The middle longitudinal plates and one of the side plates form an L-shaped bed board which is convenient for side sleep when the side plate is turned up. A movable leg bending plate is folded on the lower bed board, and a movable frame is located beneath the lower bed board. The head plate and the foot plate are respectively composed of a center fixed plate and active plates on both sides of the cent fixed plate, such that the bed can be narrowed. A monitor display is mounted in the middle of the foot plate. A bed foot rack is composed of a disc, a storage basket, four wheels and a pair of U-shaped foot rack pipes. A urinal extended from a toilet seat is connected with a head band. Two horizontally extended parts of the lower end of the back plate near the hand rest plates are respectively provided with a link shaft. Pull rods are installed under both ends of the hand rest plate, and an elastic wrapper of the hand rest plate is arranged beneath the pull rods. An excrement storage box is hung under the shielding plate at the center bottom side of the bed body.

By the available technologies, the present invention has improved, perfected and developed significantly on the basis of a Chinese application 200410046881.7.

Herein, turn-over refers to the turn-over of the whole bed body except the head plate and the foot plate and bed foot racks. The bed body comprises the middle longitudinal plates, the left and right side plates, the shielding plate, the excrement storage box, etc.

The link shafts, whose sections are in fan shape, are inserted in the two horizontally extended parts of the lower end of the back plates near the hand rest plates, and belong to an improvement of a shaft connector. The shaft connector as a multiway shaft can be folded upwards, downwards, leftwards and rightwards, and its folding point is on the centerline. The link shafts only can be folded upwards in addition to performing conjoined rotation, and can be matched with the back plates and hand rest plates. The folded point is off-center and is moved above the bed board. The hinge ends of the link shafts and the hip leaning plates are provided with protruding tenons. When the push rod motor is started and the hip leaning plates are folded by the push rod of the side plate, it has the function for synchronously folding the side pillow plates. Then, the hand rest plates are folded together with it and slide outwards along the runner because of the extrusion force of the patient arms, and as such the side plates form U-shaped side plates to fit for the side sleep of all kinds of patients.

In the aforementioned excrement storage box, a heater of an automatic cleaning and drying system and a contact tip for a temperature controller are arranged in a water tank of the excrement storage box. The excrement storage opens up by rotating at 90° using the stud of the excrement storage box as the centre. The opened excrement storage box, the funnel and the bed pan are totally exposed to facilitate water injection and bed pan cleaning.

The bed in a narrowed form refers to the simultaneous narrowing of the bed board, the head plate and the foot plate. The bed board is narrowed by folding the left and right side plates of the bed. The head plate and the foot plate are narrowed because the push rod motor installed in the head plate and the foot plate simultaneously pulls the left and right active plates inwards.

The function of the aforementioned movable frame is to realize the exchange of the toilet cover. The movable frame is composed of the toilet cover, the toilet seat, the movable frame and pendulum rods. The components form two active quadrangles if it is viewed from a plane, and the rollers of the toilet cover and the toilet seat are respectively inserted in a limit runner. Because the movable frame is moved forwards and backwards under the action of the push rod motor, the rollers slide horizontally and vertically in the limit runner to achieve the aim that the toilet cover and toilet seat alternatively fill a toilet aperture, so as to achieve the exchange of the toilet cover.

A hand rest plate wrapper is made of warp-weft bidimentional elastic fabric or rubber. It is mainly used for covering and decorating disconnected side plates. The upper part is installed under the edge of the bed; the lower part is installed on the extended parts of the lower end of the back plate near the hand rest plate; and the left part and right parts are respectively installed in the slots of the side pillow plate and hip leaning plate.

The urinal and the head band are shown in FIG. 4. In the FIG. 4, the unisex urinal is integrally connected with a safety belt. A forehead band and a jaw holding sleeve prevent a patient's head from falling from the pillow when the patient is unconscious while leaning to one side. A hand rest bag plays the function of double insurance, and it circumvents the problem that a patient's hand is clamped when the change of the side plates and the hand rest plates occurs. The urinal is suitable for all men and women, belongs to disposable appliances, and is disposable after one person uses it.

A L-shaped bed board is formed by the combination of the middle longitudinal plates, one side plate laid flat and the other side plate turned up. The L-shaped bed board is used by patients who are slightly injured and feel inconvenient to turn over while they are conscious. For patients in a vegetative state, or for using the bed in a narrowed form for ease of transportation, a U shaped bed is formed. The shape is selected in accordance with the requirements of patients. The L-shaped bed board is formed under the control of a single chip microcomputer (SCM). When the left side plate is turned up, the right side plate is immobile; when the right side plate is turned up, the left side plate is immobile. Thus, back-and-forth movement is automatically achieved.

One end of each pull rod is installed on screw pins on both sides of the extended parts of the lower end of the back plate near the hand rest plate, and the other end is installed in the position limiting the lower part of the hand rest plate. When the side plate is laid flat, the pin shaft of the lower part of the hand rest plate is moved inwards in the runner of the pull rod, and the pull rod plays a protection function in the change of the hand rest plate.

The reason why the hand rest plate is automatically adjustable in accordance with patients with different build and automatically controls the arm embedding depth is shown in FIG. 7: when the side plate AO is upwards rotated by using O as the rotating centre, point B at the upper end of the hand rest plate BC slides from point A to point B through the runner; the point C at the lower end of the hand rest plate slides from point O₁ to point C through the runner of the pull rod. Therefore, the distance from the side plate to point C can be changed by rotating the side plate at different angles to achieve the purposes of fitting patients with different build and changing the arm embedding depth.

Compared with the prior art, the present invention has the following advantages: 1. the L-shaped bed board and concave hand rest plates enable the hospital bed to be more humane; 2. the link shafts greatly simplified and rationalized the bed structure; 3. the exchange of toilet cover is accurate and convenient; 4. the design of the pull rod and excrement storage box is simple and precise; 5. the urinal and head band ensure safety and the head band is convenient for patients to wear.

The bed enables all functions to be guaranteed, and adds the functions of monitoring, traction, etc. Because the bed is fully made of plastic and the microcomputer is introduced, the bed is more suitable for commercial manufacture, and has the advantages of simplified structure, increased degree of automation, beautiful appearance, and safer and more reliable performance.

### FIGURE DESCRIPTION

Further explain the present invention by combining with the figures.

FIG. 1 is the structure diagram of the bed surface of the present invention;

FIG. 2 is the structure diagram of the excrement storage box of the present invention;

FIG. 3 is the structure diagram of the bed foot rack of the present invention;

FIG. 4 is the structure diagram of the urinal and the head band of the present invention;

FIG. 5 is the structure diagram of mutual exchange between the toilet cover and toilet seat of the present invention;

FIG. 6 is the structure diagram which shows the cross section of the present invention with one side plate turned up and the hand rest plate glided;

FIG. 7 is the schematic diagram of the automatic adjustment of the hand rest plates of the present invention;

FIG. 8 is the diagram of folding of the L-shaped bed board and the shape of the concave hand rest plates of the present invention.

The figure numbers and corresponding component names are listed in the following table:

| Number | Name |
|---|---|
| 1 | Side Pillow |
| | Plate |
| 2 | Centre Fixed |
| | Plate |
| 3 | Buckle |
| 4 | Back Plate |
| 5 | Link Shaft |
| 6 | Edge of Bed |
| 7 | Toilet Aperture |
| 8 | Hip Leaning |
| | Plate |
| 9 | Lower Bed |
| | Board |
| 10 | Traction |
| | Mechanism |
| 11 | Leg Bending |
| | Plate |
| 12 | Monitor |
| | Display |
| 13 | Centre Fixed |
| | Plate |
| 14 | Active Plate |
| 15 | Plate End Shaft |
| 16 | Hinge Shafts In |
| | The Middle |
| | Section |
| 17 | Pressure |
| | Sensor |
| 18 | Hand rest Plate |
| 19 | Pull Rod |
| 20 | Shielding |
| | plate |
| 21 | Bolt |
| 22 | Water Tank |
| 23 | Excrement |
| | Storage Box |
| 24 | Bed Pan |
| 25 | Handle |
| 26 | Funnel |
| 27 | Wheel |
| 28 | Storage |
| | Basket |
| 29 | Disc |
| 30 | Foot Rack |
| | Pipe |
| 31 | Buckle Sheet |
| 32 | Forehead |
| | Band |
| 33 | Jaw Holding |
| | Sleeve |
| 34 | Hand rest |
| | Bag |
| 35 | Safety Belt |
| 36 | Opening |
| 37 | Rubber |
| | Sheath |
| 38 | Baffle Plate |
| 39 | Flexible Rib |
| 40 | Plug |
| 41 | U-Frame |
| 42 | Limit Runner |
| 43 | Toilet Cover |
| 44 | Toilet Cover |
| | Roller |
| 45 | Toilet Seat |
| 46 | Toilet Seat |
| | Roller |
| 47 | Pendulum |
| | Rod |
| 48 | Movable |
| | Frame |
| 49 | Side Plate |
| 50 | Exposed |
| | Body |
| 51 | Tenon |
| 52 | Push Rod |
| | Motor |
| 53 | Side Plate |
| | Push Rod |
| 54 | Runner |
| 55 | Screw Pin |
| 56 | Elastic |
| | Wrapper of |
| | Hand rest |
| | Plate |
| 57 | Pin Shaft |

### SPECIFIC EMBODIMENTS

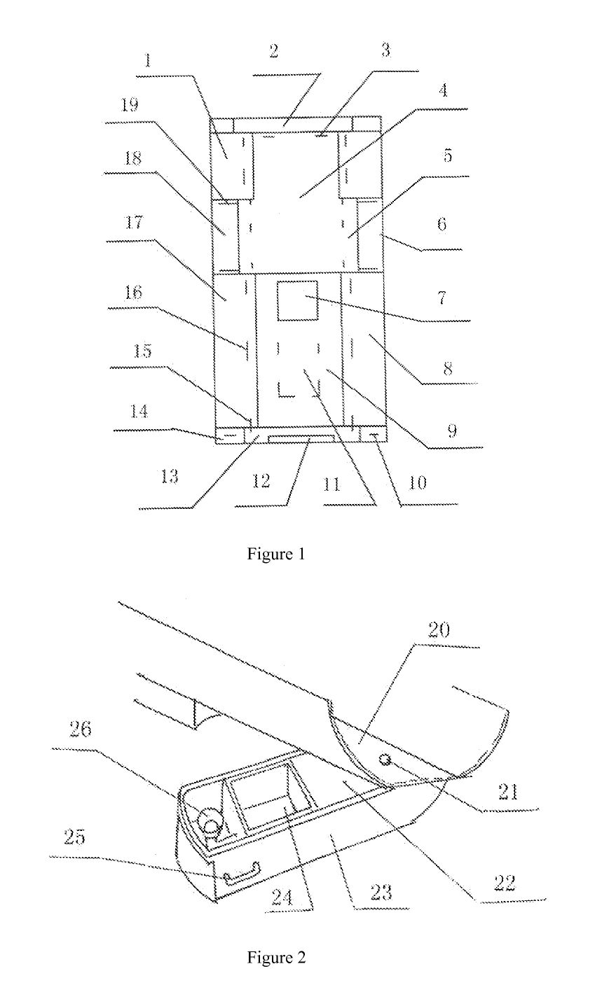

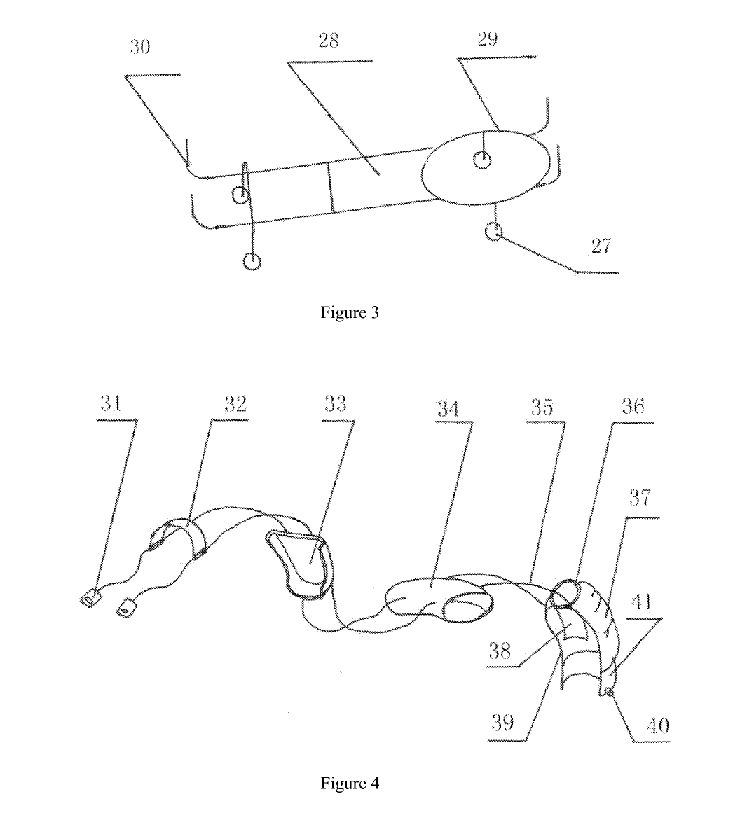

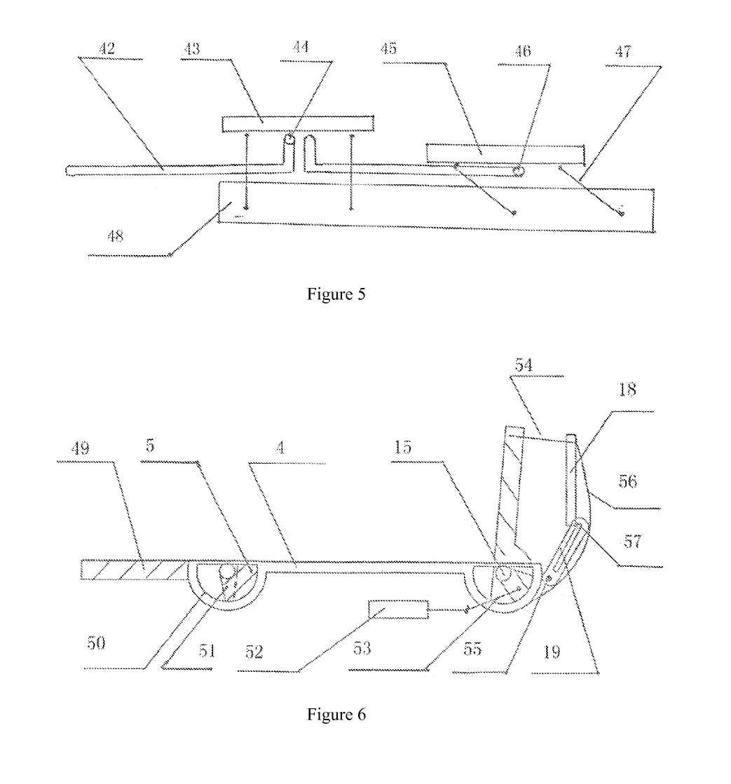

For embodiments of the present invention, refer to FIGS. 1 to 8.

The L-shaped bed board refers to the shape of the bed board which is formed by the middle longitudinal plates (4, 9) and one of the side plates (49) turned up. The left and right side plates are respectively composed of a side pillow plate (1), a hand rest plate (18) and a hip leaning plate (8), with the above three plates disconnected from one another. A pressure sensor (17) is located on the upper end of the hip leaning plate (8). The side plate is turned up by cooperation with a plate end shaft (15) at the foot plate, a plurality of hinge shafts (16) in the middle section of the lower bed board and a link shaft (5). The shafts are all on the same line, and the turning angle is from 0° to 110°. When a patient turns over, the shape of the side plates can be automatically selected to be U-shape or L-shape according to the condition of the patient, and the L-shaped side plates are formed under the control of a single chip microcomputer (SCM) in order to achieve the automatic alternation of turning over to the left or to the right.

The whole bed is narrowed by simultaneously turning up the left and right side plates, and then inserting the left and right side plates and the active plates (14) on both sides of head plate into the centre fixed plate (2, 13) of the head plate. The inner part of the active plates is provided with a traction mechanism (10) which can be extended by a traction belt.

The excrement storage box (23) is exposed, and a funnel (26), a bed pan (24) and a water tank (22) are arranged in the excrement storage box. The water pipe below the funnel (26) is connected with the water tank (22) by the bed pan (24). The excrement storage box (23) is hung under the platform of the shielding plate (20) by a bolt (21) of the water tank, and two handles (25) are arranged on both sides at the section of the funnel (26).

The pull rod (19) is formed from an iron plate. One end of the pull rod with a hole is installed on one side of the extended parts at the lower end of the back plate (4) near the hand rest plate section, and the other end of the pull rod with a runner is matched with a pin shaft (57) below the hand rest plate (18).

The link shafts (5) are located at and inserted into the two extended parts of the back plate (4) near the section of the hand rest plates (18). The upper end of the link shaft is connected with the side pillow plate (1), and the lower end is hinged with the hip leaning plate (8) in a folding mode.

The movable frame (48) is provided with eight pendulum rods respectively installed on both sides of the toilet seat (45) and the toilet cover (43). Under the forward and backward movement of the movable frame (48), the toilet seat (45) and the toilet cover (43) are driven by the rollers (44, 46) and the limit runners (42) to alternately fill the toilet aperture (7).

The wrapper (56) of the hand rest plate is made of warp-weft bidimentional elastic fabric or rubber, and is located below the hand rest plate (18) when the wrapper of the hand rest plate is positioned flatly. The upper part of the wrapper is fixed to the edge of the hand rest plate close to the bed edge (6); the lower part of the wrapper is fixed to the lower end of the extended part of the back plate (4); and the left and right parts of the wrapper are respectively inserted in the slots in the side pillow plate (1) and the hip leaning plate (8).

The urinal is composed of a opening (36), two flexible ribs (39), a baffle plate (38), left and right plugs (40) and a rubber sheath (37), with both sides of the opening (36) connected with the safety belts (35) of the head band.

The head band is composed of buckle pieces (31), a forehead band (32), a jaw holding sleeve (33), a hand rest bag (34) and two serially connected safety belts (35). One end of each safety belt is inserted into the socket of buckle (3) on the head plate by the buckle piece, and the other end is connected with one side of the urinal opening (36).

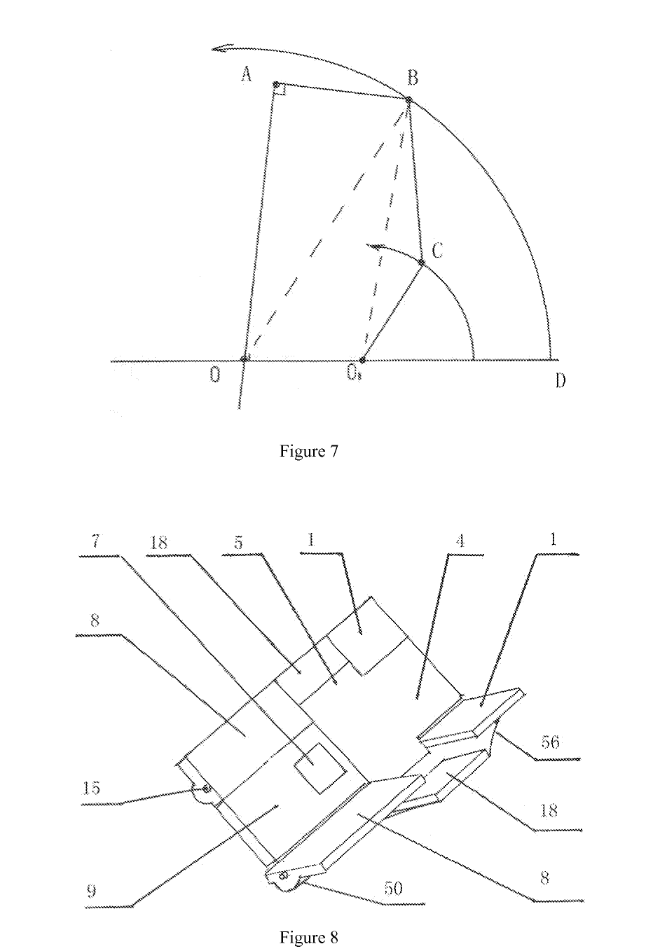

The hand rest plate (18) is adjustable automatically according to the different build of patients to automatically control the arm embedding depth, and the principle is shown in FIG. 7: In the polygon ABCOO₁, O represents the rotating center of the side plate, O₁ represents the rotating center of the pull rod, BC represents the hand rest plate, AB represents a sliding groove, AO represents the side plate, OB and O₁C represent the two pendulum rods, and O₁C also works as the pull rod. When the values of sides AO, OO₁, AB, BC and CO₁ are given and the sides respectively are rotated around O and O₁ in the same direction, <CO₁D increases as long as <AOD increases. When the values of sides OB and OO₁ are given, corresponding side BO₁ increases as long as <BOO₁ increases. Similarly, when side BO₁ increases, corresponding angle <BCO₁ increases; correspondingly, the vertical line from side BO₁ to point C is decreased, and the vertical line from side AO to point C is decreased at the same time; that is to say, the value of <BOD is in inverse proportion to the length of the vertical line from side AO to point C. The lengths of the two pendulum rods OB and O₁C are different, but the length of BC is fixed; so the different turning angles of the main pendulum rods results in the different distances from point C to side AO (in inverse proportion) As the build and the limbs of a person are in proportion, when a patient with thin and small build sleeps on the bed, the turning angle of the side plates will be larger, and the arm embedding depth is accordingly small, which is coincide with the scale of body configuration; and thus, the purpose of automatic adjustment is achieved.

Besides the turn-over manners of turning over the back plate and rolling the mattress, the known turn-over nursing beds have another turn-over manner, that is to laterally divide the bed into three sections. No concave hand rest place is provided, and the narrow side plates are not suitable for side sleep in bending over or bending leg posture; therefore, the hands will be pressed painfully in such posture. If the side plates are intended to form a concave space, the hand rest plates need to be divided into three sections and fully disconnected, which is difficult to design and use. The present invention makes essential breakthroughs in the aforementioned difficult problems, and presents solutions including: 1. the hand rest plates are reconnected automatically after the disconnection; 2. the depth of the hand rest plate is adjustable automatically according to the patients with different build, realized by changing the turning angle of the side plates and using the pull rod 19; 3. the operation is simple and convenient.

All the known superior-quality nursing beds adopt barrier type guard rail boards with holes, with the advantages of ease of design, attractive appearance, and safety precautions against falling, but with the disadvantages that patient fingers are easily clamped, and that the body of the patient tends to slide downward and has friction with the bed during the turn-over. The guard rail board of the our invention is formed by turning up the side pillow plates (1), the hand rest plates (18) and the hip leaning plates (8), which has the following advantages: 1. the guard rail board is hidden; 2. the bed dimension after turning up is reduced to the utmost extent; 3. the guard rail board is close to the patient, so the patient's body is ensured not to slide, and additionally, the problem of collecting excrement during turn-over is solved.

The aim of the present invention is to provide a multifunctional nursing bed which effectively prevents bedsore, solves the problem of collecting excrement on the bed, and particularly solves the problems of collecting excrement during turn-over and preventing the patient from being injured by the guard rail board. The multifunctional nursing bed is convenient, portable, shapely, comfortable and safe, and is provided with the instruments for contraction, traction, monitoring, etc.

1. A multifunctional turn-over nursing bed is characterized in that the whole bed board is composed of nine plates with the following characteristics: (a) middle longitudinal plates are composed of a back plate (4), a lower bed board (9) and a toilet cover (43); (b) left and right side plates (49) are respectively composed of a side pillow plate (1), a hand rest plate (18) and a hip leaning plate (8), with the above three plates disconnected from one another; (c) the middle longitudinal plates and one of the side plates (49) turned up form an L-shaped bed board which is convenient for side sleep; (d) a leg bending plate (11) is folded on the lower bed board (9), and a movable frame (48) is located beneath the lower bed board; (e) a head plate and a foot plate are respectively composed of a centre fixed plate (2, 13) and active plates (14) on both sides of the centre fixed plate (2, 13), such that the bed can be narrowed; (f) a monitor display (12) is mounted outboard in the middle of the foot plate; (g) a bed foot rack is composed of a disc (29), a storage basket (28), four wheels (27) and a pair of U-shaped rack pipes (30); (h) a urinal extended from a toilet seat (45) is connected with a head band; (i) the extended parts of the lower end of the back plate (4) near the hand rest plates are respectively provided with a link shaft (5); (j) pull rods (19) are installed under both ends of the hand rest plates (18), and an elastic wrapper (56) of the hand rest plate is arranged beneath the pull rods; (k) an excrement storage box (23) is hung under a shielding plate (20) at the center bottom side of the bed board.

2. The multifunctional turn-over nursing bed according to claim 1 has the following characteristics: (a) the L-shaped bed board indicates the shape of the bed board which is formed by middle longitudinal plates (4,9) and one of the side plates (49) turned up; (b) the left and right side plates are respectively composed of a side pillow plate (1), a hand rest plate (18) and a hip leaning plate (8), with the above three plates disconnected from one another; (c) a pressure sensor (17) is located on the upper end of the hip leaning plate (8); (d) the side plate is turned up by cooperation with a plate end shaft (15) at the foot plate, a plurality of hinge shafts (16) in the middle section of the lower bed board and a link shaft (5); (e) the shafts are on the same line, and the turning angle is from 0° to 110°.

3. The multifunctional turn-over nursing bed according to claim 1 has the following characteristics: (a) the whole bed is narrowed by simultaneously turning up the left and right side plates, and then inserting the left and right side plates and the active plates (14) on both sides of head plate into the centre fixed plates (2, 13) of the head plate; (b) the inner part of the active plates is provided with a traction mechanism (10) which can be extended by a traction belt.

4. The multifunctional turn-over nursing bed according to claim 1 has the following characteristics: (a) the excrement storage box (23) is exposed, and a funnel (26), a bed pan (24) and a water tank (22) are arranged in the excrement storage box; (b) the water pipe below the funnel (26) is connected with the water tank (22) by the bed pan (24); (c) the excrement storage box (23) is hung under the platform of the shielding plate (20) by a bolt (21) of the water tank, and two handles (25) are arranged on both sides of the bed at the section of the funnel (26).

5. The multifunctional turn-over nursing bed according to claim 1 has the following characteristics: (a) the pull rod (19) is formed from an iron plate; (b) one end of the pull rod with a hole is installed on one side of the extended parts at the lower end of the back plate (4) near the hand rest plate section, and the other end of the pull rod with a runner is matched with a pin shaft (57) below the hand rest plate (18).

6. The multifunctional turn-over nursing bed according to claim 1 has the following characteristics: (a) the link shafts (5) are located at and inserted into the two extended parts of the back plate near the section of the hand rest plates (18); (b) the cross section of the link shaft is fan-shaped; (c) the upper end of the link shaft is connected with the side pillow plate (1); (d) the lower end is hinged with the hip leaning plate (8) in a folding mode; (e) the link shaft is provided with a protruding tenon (51).

7. The multifunctional turn-over nursing bed according to claim 1 has the following characteristics: (a) the movable frame (48) is provided with eight pendulum rods which are respectively installed on both sides of the toilet seat (45) and the toilet cover (43); (b) under the forward and backward movement of the movable frame (48), the toilet seat (45) and the toilet cover (43) are driven by rollers (44, 46) and limit runners (42) to alternately fill a toilet aperture (7).

8. The multifunctional turn-over nursing bed according to claim 1 has the following characteristics: (a) the wrapper (56) of the hand rest plate is made of warp-weft bidimentional elastic fabric or rubber, and is located below the hand rest plate (18) when the hand rest plate is positioned flatly; (b) the upper part of the wrapper is fixed to the edge of the hand rest plate close to bed edge (6); (c) the lower part of the wrapper is fixed to the lower end of the extended part of the back plate (4); (d) and the left and right parts of the wrapper are respectively inserted in the slots in the side pillow plate (1) and the hip leaning plate (8).

9. The multifunctional turn-over nursing bed according to claim 1 is characterized in that the urinal is composed of an opening (36), two flexible ribs (39), a baffle plate (38), left and right plugs (40) and a rubber sheath (37), and wherein both sides of the opening (36) are connected with safety belts (35) of the head band.

10. The multifunctional turn-over nursing bed according to claim 1 has the following characteristics: (a) the head band is composed of buckle pieces (31), a forehead band (32), a jaw holding sleeve (33), a hand rest bag (34) and two serially connected safety belts (35); (b) one end of each safety belt is inserted into the socket of the buckle (3) on the head plate by the buckle piece, and the other end is connected with one side of the urinal opening (36).

11. The multifunctional turn-over nursing bed according to claim 1 has the following characteristic: (a) the hand rest plates (18), the side plates (49), grooves (54) and the rods (19) are interrelated; (b) when the widths of the side plates (49, AO), U-shaped hand rest plate grooves (54, AB) and the hand rest plates (18, BC), the length of the pendulum rod (CO₁) and the distance between the two rotating centers (OO₁) are given, and the junctions are moving points, the distance between the hand rest plates (18) and the side plates (49) is changed by turning the side plates (49) and the pendulum rods (19) around the different rotating centers in the same direction, so that the hand rest plates are automatically adjusted according to the different build of patients to automatically control the hand rest depth of arms.

12. The multifunctional turn-over nursing bed according to claim 1 has the following characteristic: (a) the hand rest plates (18) are located in the middle sections of the side plates (49); (b) the wheels at the upper ends of the hand rest plates are respectively matched with the runners (54) on the U-shaped frames of the hand rest plates; (c) the lower ends of the hand rest plates are connected by steel wires, and the upper ends move outwards along the runners (54); (d) the side plates (49) form a concave shape after the hand rest plates are moved down.

13. The multifunctional turn-over nursing bed according to claim 1 has the following characteristic: (a) the toilet seat (45) is wide; (b) a defecation opening is formed in the centre of the toilet seat, which is different from the prior art in which the defecation opening is directly formed in the mattress; (c) the defecation opening is located in the toilet aperture (7) on the upper part of the lower bed board (9), and is alternate with the toilet cover (43); (d) in addition, both sides of the defecation opening are provided with a plurality of drain grooves.

14. A multifunctional turn-over nursing bed has the following characteristic: (a) the whole bed board is composed of nine plates, wherein, middle longitudinal plates are composed of a back plate (4), a lower bed board (9) and a toilet cover (43); (b) left and right side plates (49) are respectively composed of a side pillow plate (1), a hand rest plate (18) and a hip leaning plate (8), with the above three plates disconnected from one another; (c) the middle longitudinal plates and one of the side plates (49) turned up to form an L-shaped bed board which is convenient for side sleep; (d) the two extended parts of the lower end of the back plate (4) near the hand rest plates are respectively provided with a link shaft (5).
